(19) United States
(12) Patent Application Publication
(10) Pub. No.: US 2025/0155344 A1
(43) Pub. Date: May 15, 2025

(54) CUTTING COEFFICIENT IDENTIFICATION SYSTEM IN MACHINE TOOL AND CUTTING COEFFICIENT IDENTIFICATION METHOD IN MACHINE TOOL

(71) Applicant: OKUMA CORPORATION, Niwa-Gun (JP)

(72) Inventor: Shunsuke FUJIMAKI, Niwa-Gun (JP)

(73) Assignee: OKUMA CORPORATION, Niwa-Gun (JP)

(21) Appl. No.: 18/944,037

(22) Filed: Nov. 12, 2024

(30) Foreign Application Priority Data
Nov. 13, 2023 (JP) 2023-193201

(51) Int. Cl. G01N 3/58

(52) U.S. Cl. CPC G01N 3/58

(57) ABSTRACT

A cutting coefficient identification system includes a measured cutting force acquisition unit, an estimated cutting force calculation unit, and a cutting coefficient identification unit. The measured cutting force acquisition unit acquires an average torque Tₐ of at least one of the tool main spindle motor, the workpiece main spindle motor, and the feed shaft motor. The estimated cutting force calculation unit calculates an estimated cutting force that is an average cutting force during one rotation of the tool main spindle or the workpiece main spindle, based on a calculation formula including a cutting coefficient K_{c} representing a cutting force per unit cutting cross-sectional area and a cutting coefficient K_{c} representing a cutting force per unit cutting edge length. The cutting coefficient identification unit identifies the cutting coefficient K_{c} and the cutting coefficient K_{c} by comparing the measured cutting force with the estimated cutting force.

### CROSS REFERENCE TO RELATED APPLICATION

This application claims the benefit of Japanese Patent Application Number 2023-193201 filed on Nov. 13, 2023, the entirety of which is incorporated by reference.

### FIELD OF THE INVENTION

The present disclosure relates to a cutting coefficient identification system in a machine tool, which identifies cutting coefficients used for prediction of a chatter stability limit and the like, and a cutting coefficient identification method in a machine tool.

### BACKGROUND OF THE INVENTION

Conventionally, as one of parameters that determines a machining ability in a machine tool is, there is, for example, a stability limit of self-excited chatter. When the self-excited chatter occurs during cutting machining, machining accuracy and machined surface quality of a product decrease. Accordingly, suppressing the self-excited chatter has become an objective.

For example, JP 2022-21378 A discloses that a stability limit diagram for predicting occurrence of the self-excited chatter is created using a transfer function measured by a hammering test and an estimated value of specific cutting resistance as a cutting coefficient, and using the stability limit diagram to select cutting conditions that are highly efficient and do not cause the self-excited chatter.

On the other hand, in “Chihiro Akagi, Jun′ichi Kaneko, Kenichiro Horio, The Development of the high speed automatic estimated system of the specific cutting force in the cutting resistance prediction′ The Japan Society for Precision Engineering Academic Conference Lecture Proceedings 2014A, pp669-670, 2014,” a method for identifying the cutting coefficient is disclosed. In the method, the cutting coefficient is identified by modifying the cutting coefficient such that a difference between a cutting force measured by a dynamometer, which is a sensor with a high response frequency, and the cutting force estimated by a prediction model using a temporarily determined cutting coefficient becomes small.

In a conventional cutting force prediction model, the cutting coefficients were constituted of two cutting coefficients, namely, the cutting coefficient representing the cutting force per unit cutting cross-sectional area and the cutting coefficient representing the cutting force per unit cutting edge length, for each of the cutting forces in three orthogonal directions. In “Kazuki KANEKO, Isamu NISHIDA, Ryuta SATO, and Keiichi SHIRASE, ‘Instantaneous rigid force model based on oblique cutting to predict milling force,’ The Japan Society of Mechanical Engineers Collection of Papers, Vol. 83, No. 856, 2017,” a method of identifying the cutting coefficient from a torque of a main spindle motor is disclosed by replacing the cutting coefficients described above with a single cutting coefficient in which a shear angle is a parameter is disclosed.

### SUMMARY OF THE INVENTION

However, in JP 2022-21378 A, the cutting coefficients that vary depending on a machining status, such as a combination of a tool and a workpiece material type and presence/absence of a coolant is obtained by estimation from, for example, a tool rake angle, and a friction coefficient in order to eliminate measurement work. Thus, there is a problem that it is difficult to predict the occurrence of the self-excited chatter with high accuracy.

According to “Chihiro Akagi et al.”, it is assumed that the cutting force is measured using a dynamometer with a high response frequency, dynamometers are very expensive. When the dynamometer is attached to a machine tool as part of production facilities, for example, interference is likely to occur between the dynamometer itself and the wiring. Furthermore, it is conceivable that there is decrease in loop rigidity from the tool to the workpiece. Thus, there is a problem that it is difficult to use it in an actual production site.

The cutting coefficient using the shear angle as a parameter, which is disclosed by “Kazuki KANEKO et al.”, merely replaces only the cutting coefficient representing the cutting force per the unit cutting cross-sectional area among the conventional cutting coefficients. Thus, there is a problem that identification accuracy is decreased for materials with a large cutting coefficient that represents the cutting force per unit cutting edge length, such as a titanium alloy and a Ni-based heat-resistant alloy.

Therefore, the present disclosure has been made in consideration of the above problems. It is an object of the present disclosure to provide a cutting coefficient identification system and a cutting coefficient identification method in a machine tool, which can identify the cutting coefficient with high accuracy without using additional sensors and irrespective of the workpiece material.

In order to achieve the above-described object, a first configuration of the disclosure is a cutting coefficient identification system in a machine tool. The machine tool includes at least one of a tool main spindle with a tool attached and driven by a tool main spindle motor; and a workpiece main spindle with a workpiece attached and driven by a workpiece main spindle motor; and a feed shaft that relatively moves the tool and the workpiece by a feed shaft motor. The cutting coefficient identification system includes a measured cutting force acquisition unit, a tool information acquisition unit, a cutting condition acquisition unit, an estimated cutting force calculation unit, and a cutting coefficient identification unit. The measured cutting force acquisition unit acquires an average torque Tₐ of at least one of the tool main spindle motor, the workpiece main spindle motor, and the feed shaft motor in an optional period a while the tool is cutting the workpiece and calculates a measured cutting force. The tool information acquisition unit acquires tool information including a tool edge count corresponding to the measured cutting force. The cutting condition acquisition unit acquires cutting conditions that correspond to the measured cutting force, the cutting conditions including a relative movement amount between the tool and the workpiece during one rotation of the tool main spindle or the workpiece main spindle and a depth of cut. The estimated cutting force calculation unit calculates an estimated cutting force that is an average cutting force during one rotation of the tool main spindle or the workpiece main spindle, based on a calculation formula including a cutting coefficient K_{c} representing a cutting force per unit cutting cross-sectional area, a cutting coefficient K_{c} representing a cutting force per unit cutting edge length, the tool edge count, the relative movement amount, and the depth of cut. The cutting coefficient identification unit identifies the cutting coefficient K_{c} and the cutting coefficient K_{c} by comparing the measured cutting force with the estimated cutting force.

In another aspect of the first configuration of the disclosure, which is in the above-described configuration, further includes a limit cutting condition calculation unit that calculates a limit cutting condition that includes at least one of a rotation speed of the tool main spindle or the workpiece main spindle, the relative movement amount between the tool and the workpiece during one rotation of the tool main spindle or the workpiece main spindle, and the depth of cut, which are the limits of the machining ability of the machine tool, using at least one of the cutting coefficient K_{c} and the cutting coefficient K_{c}.

In yet another aspect of the first configuration of the disclosure, which is in the above-described configuration, the measured cutting force acquisition unit calculates the measured cutting force by further using an average torque Tb in an optional period b during which the tool is cutting the workpiece under cutting conditions different from the cutting conditions in the optional period a.

In yet another aspect of the first configuration of the disclosure, which is in the above-described configuration, the measured cutting force acquisition unit calculates the measured cutting force by further using an average torque T_{c} in an optional period c during non-cutting.

In yet another aspect of the first configuration of the disclosure, which is in the above-described configuration, parameters that determine a limit of the machining ability include: at least one of an output upper limit of at least one of the tool main spindle motor, the workpiece main spindle motor, and the feed shaft motor; a bending stress of the tool; a shear stress of the tool; a quality requirement value of the workpiece; and a stability limit of self-excited chatter.

In order to achieve the above-described object, a second configuration of the disclosure is a cutting coefficient identification method in a machine tool. The machine tool includes at least one of a tool main spindle with a tool attached and driven by a tool main spindle motor and a workpiece main spindle with a workpiece attached and driven by a workpiece main spindle motor, and a feed shaft that relatively moves the tool and the workpiece by a feed shaft motor. The cutting coefficient identification method includes: acquiring an average torque Tₐ of at least one of the tool main spindle motor, the workpiece main spindle motor, and the feed shaft motor in an optional period a while the tool is cutting the workpiece, and calculating a measured cutting force; acquiring tool information including a tool edge count corresponding to the measured cutting force; acquiring cutting conditions that correspond to the measured cutting force, the cutting conditions including a relative movement amount between the tool and the workpiece during one rotation of the tool main spindle or the workpiece main spindle and a depth of cut; calculating an estimated cutting force that is an average cutting force during one rotation of the tool main spindle or the workpiece main spindle, based on a calculation formula including a cutting coefficient K_{c} representing a cutting force per unit cutting cross-sectional area, a cutting coefficient K_{c} representing a cutting force per unit cutting edge length, the tool edge count, the relative movement amount, and the depth of cut; identifying the cutting coefficient K_{c} and the cutting coefficient K_{c} by comparing the measured cutting force with the estimated cutting force.

According to the present disclosure, by using the torque of the motor attached to the machine tool, each of the cutting coefficient representing the cutting force per unit cutting cross-sectional area and the cutting coefficient representing the cutting force per unit cutting edge length is identified. Thus, the cutting coefficients can be identified with high accuracy without using additional sensors and irrespective of the workpiece material.

### BRIEF DESCRIPTION OF THE DRAWINGS

FIG. 1 is a schematic configuration diagram illustrating a cutting coefficient identification system in a machine tool.

FIG. 2 is a flowchart illustrating a method for predicting machining ability.

FIGS. 3A and 3B illustrate motor torque histories according to a period a, a period b, and a period c, FIG. 3A is a motor torque history of a main spindle, and FIG. 3B is a motor torque history of a feed shaft.

FIGS. 4A and 4B are schematic diagrams illustrating states where milling machining is performed in a machining center, FIG. 4A is a top view, and FIG. 4B is a side view.

FIG. 5 is a graph illustrating a relationship between a main spindle rotation speed and a radial depth of cut, which becomes an output upper limit of a main spindle motor in milling machining.

FIG. 6 is a graph illustrating a relationship between a main spindle rotation speed and a feeding amount per main spindle rotation, which becomes an output upper limit of a feed shaft motor in milling machining.

FIG. 7 is a graph illustrating a relationship between the radial depth of cut and the feeding amount per main spindle rotation, which becomes an allowable bending stress of a tool in milling machining.

FIG. 8 is a graph illustrating a relationship between the feeding amount per main spindle rotation and an axial depth of cut, which becomes an allowable shear stress of a tool in milling machining.

FIG. 9 is a graph illustrating a relationship between the radial depth of cut and the axial depth of cut, which is a requirement value of surface roughness of a workpiece in milling machining.

FIG. 10 is a graph illustrating a relationship between the main spindle rotation speed and the axial depth of cut, which becomes a stability limit of self-excited chatter in milling machining.

### DETAILED DESCRIPTION OF THE INVENTION

The following describes embodiments of the present disclosure based on the drawings.

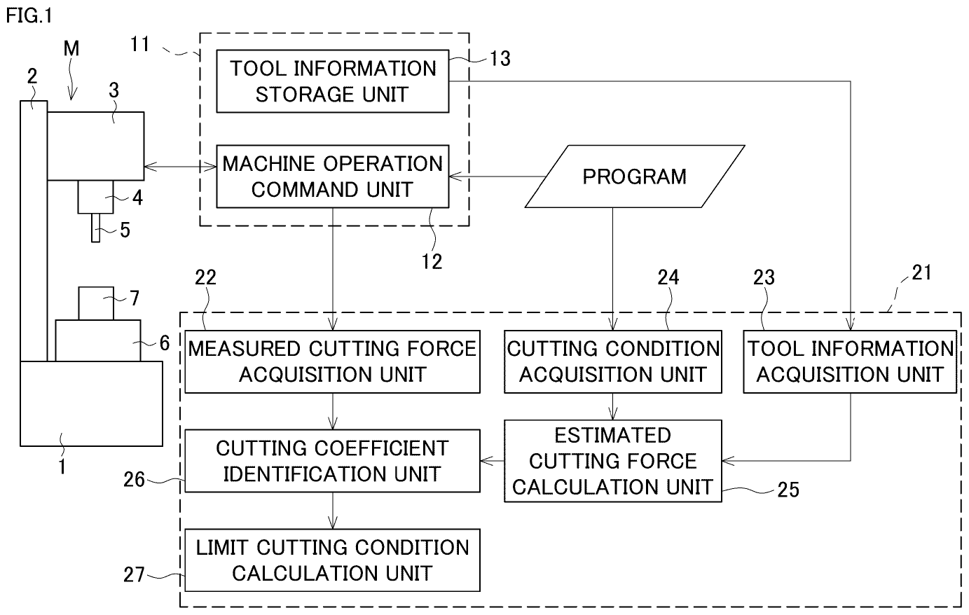

FIG. 1 is a schematic configuration diagram of a machining center that is one example of a machine tool.

A main spindle housing 3 of a machining center M includes a main spindle 4 as a tool main spindle rotatable by a main spindle motor. A tool 5 is attached to a distal end of the main spindle 4. The main spindle housing 3, which is a moving body, can be moved in a Z-axis direction by a Z-axis motor via a Z-axis ball screw as a feed shaft relative to a column 2 attached to a bed 1. A workpiece 7 is fixed on a table 6 that is a moving body included in the machining center M. The table 6 is movable on the bed 1 in an X-axis direction and a Y-axis direction that are orthogonal to one another. The movement of the table 6 in the X-axis direction is performed by an X-axis motor via an X-axis ball screw as a feed shaft. The movement of the table 6 in the Y-axis direction is performed by a Y-axis motor via a Y-axis ball screw as a feed shaft.

The machining center M includes an NC device 11 that can control itself. The NC device 11 includes a CPU and a memory connected to the CPU and achieves its operations by using them.

The NC device 11 includes a machine operation command unit 12 that controls each part such as the main spindle motor and each feed shaft motor based on a program input by an operator through an input unit such as a keyboard or a touch panel (not illustrated). Cutting is performed by the machine operation command unit 12 commanding rotation of the tool 5 and a relative movement between the tool 5 and the workpiece 7.

The machining center M further includes a cutting coefficient identification system 21. The cutting coefficient identification system 21 includes a measured cutting force acquisition unit 22, a tool information acquisition unit 23, a cutting condition acquisition unit 24, an estimated cutting force calculation unit 25, a cutting coefficient identification unit 26, and a limit cutting condition calculation unit 27.

While the cutting coefficient identification system 21 is assumed to be included in the NC device 11, it may be included in a computer that is separate from the machining center M and is mechanically and electrically connected to the machining center M.

The measured cutting force acquisition unit 22 acquires a torque of each of the main spindle motor and the feed shaft motor from the machine operation command unit 12 and calculates the measured cutting force.

The tool information acquisition unit 23 acquires the tool information including a tool edge count Z and a tool diameter D from a tool information storage unit 13 that stores the tool information included in the NC device 11.

Based on the program, the cutting condition acquisition unit 24 acquires the cutting conditions including a main spindle rotation speed S, a feeding amount fᵣ per main spindle rotation corresponding to a relative movement amount between the tool 5 and the workpiece 7 during one rotation of the main spindle 4, a tool axial depth of cut dₐ, and a tool radial depth of cut dr.

The estimated cutting force calculation unit 25 calculates the estimated cutting force based on the tool information acquired by the tool information acquisition unit 23 and the cutting conditions acquired by the cutting condition acquisition unit 24.

The cutting coefficient identification unit 26 compares the measured cutting force acquired by the measured cutting force acquisition unit 22 with the estimated cutting force calculated by the estimated cutting force calculation unit 25 to identify the cutting coefficient.

The limit cutting condition calculation unit 27 calculates each combination of the main spindle rotation speed S, the feeding amount fᵣ per main spindle rotation, the tool axial depth of cut dₐ, and the tool radial depth of cut dᵣ, which are the limits of the machining ability. The calculation of the limit cutting condition calculation unit 27 is performed based on the cutting coefficient identified by the cutting coefficient identification unit 26 and the tool information.

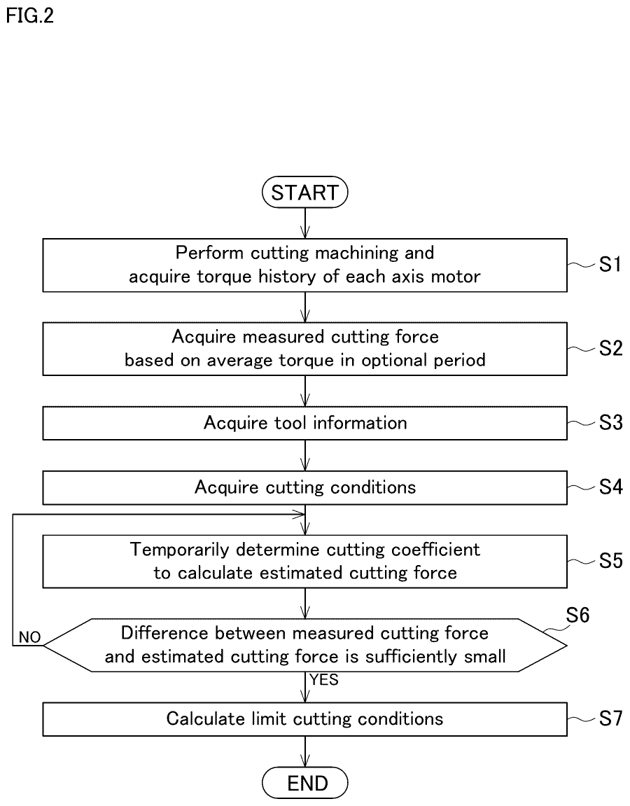

Subsequently, a machining ability prediction method of the machining center M using the cutting coefficient identification system 21 is described. First, a cutting coefficient identification method by the cutting coefficient identification system 21 is described based on a flowchart in FIG. 2. FIG. 2 is the flowchart illustrating a machining ability prediction method. S1 to S7 refer to Steps 1 to 7, respectively. S1 to S7 are achieved by each of the units 22 to 27 included in the cutting coefficient identification system 21 appropriately executing the above-described operations.

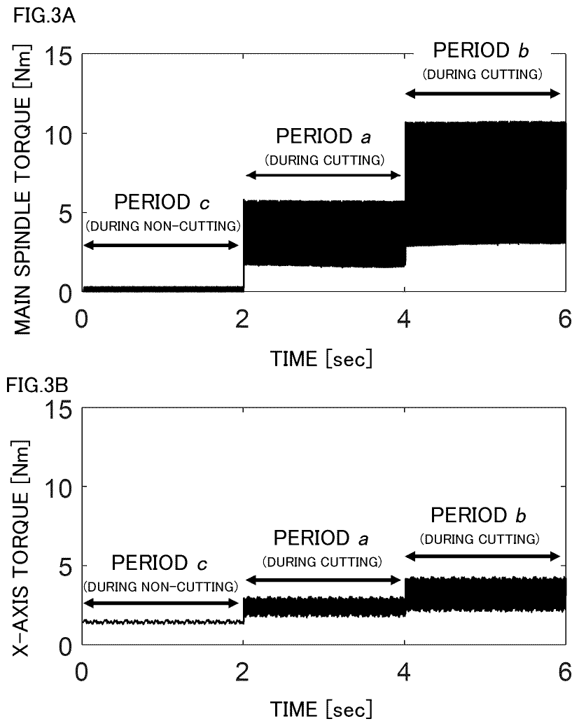

In S1, after actually performing the cutting machining of the workpiece 7 using the tool 5, a torque history of each axis motor as illustrated in FIGS. 3A and 3B is acquired.

Then, in S2, the cutting force in the axial direction of each axis motor is calculated based on a torque Tₐ in an optional period a during cutting and a torque T_{c} in an optional period c during which each axis motor is operating and the cutting is not performed among the acquired torque history. S1 and S2 are cutting force acquisition steps in the present disclosure.

In order to accurately capture the cutting phenomenon that is performed at high speed, it can be said that the accuracy is insufficient only with specific values in a controllable range of each axis motor. Accordingly, in the cutting force acquisition step, an average value for each optional period that can be acquired with high accuracy as a torque value used for calculating the cutting force is employed. For example, a cutting force Fₓₘ that the workpiece 7 receives in the X-axis direction in the period a is calculated using Formula 1. The calculation is performed based on a ball screw specification such as a lead L and mechanical efficiency n that a machine information acquisition unit (not illustrated) included in the cutting coefficient identification system 21 has acquired from a machine information storage unit (not illustrated) included in the NC device 11. The calculation is performed also based on an average torques Tₐₓ and T_{cx} in the period a and the period c of the X-axis motor. For also the Y-axis motor and the Z-axis motor, by using a calculation formula similar to Formula 1, cutting forces F_{ym}, F_{zm} in the respective axial directions can be calculated from average torques T_{ay}, T_{az}, T_{cy}, and T_{cz} in the period a and the period c of the Y-axis motor and the Z-axis motor.

$${F}_{xm} = \frac{2 π η}{L} ( {T}_{ax} - {T}_{cx} ) \qquad Formula 1$$

In the period a, a cutting force Fₜₘ that a cutting edge of the tool 5 receives in a tool tangential direction, namely, in a rotation direction of the main spindle 4 is calculated using Formula 2 based on average torques Tₐₛ, T_{cs} of the main spindle motor in the period a and the period c.

$${F}_{tm} = \frac{2}{D} ( {T}_{as} - {T}_{cs} ) \qquad Formula 2$$

Next, in S3, the tool information is acquired, and in S4, the cutting conditions are acquired. S3 is a tool information acquisition step in the present disclosure, and S4 is a cutting condition acquisition step in the present disclosure.

Subsequently, in S5, the cutting coefficient is temporarily determined, and the estimated cutting force is calculated based on the temporarily determined cutting coefficient, the tool information acquired in S3, and the cutting conditions acquired in S4.

Furthermore, in S6, cutting coefficient identification is performed from comparison of the measured cutting force with the estimated cutting force. When a difference between the measured cutting force and the estimated cutting force is large, the cutting coefficient is temporarily re-determined, and the estimated cutting force is re-calculated. On the other hand, when the difference between the measured cutting force and the estimated cutting force is small, the cutting coefficient identification is completed.

Subsequently, in S7, based on the identified cutting coefficient and the tool information, each combination of the main spindle rotation speed S, the feeding amount fᵣ per main spindle rotation, the tool axial depth of cut dₐ, and the tool radial depth of cut dᵣ at which the machining ability reaches its limit is calculated. Then, the machining ability of the machining center M is predicted from the calculated results.

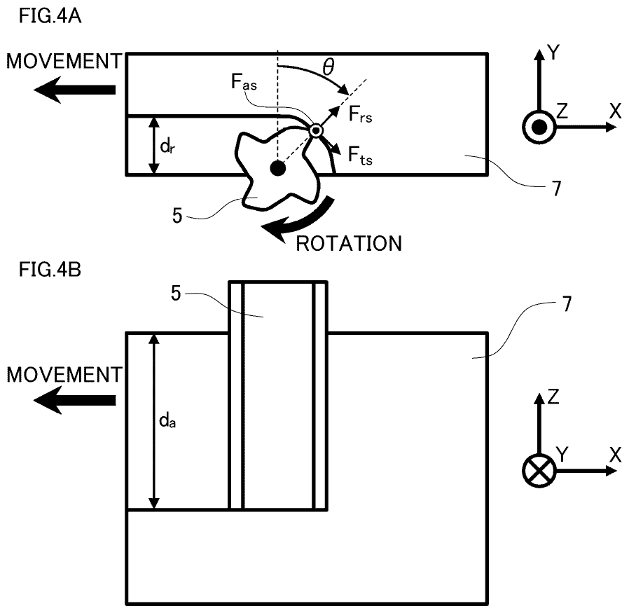

In the following, the milling machining, which is illustrated in FIG. 4, performed by relatively moving the rotated tool 5 and the workpiece 7 in the X-axis direction is described as an example. Relative positions in the Y-axis direction and the Z-axis direction of the tool 5 and the workpiece 7 are preliminarily determined such that machining can be performed.

The calculation of the estimated cutting force performed in S5 is executed by applying an instantaneous cutting force model to an end mill that has no twist angle.

At a certain tool rotation angle θ, the cutting force acting on the workpiece 7 from one cutting edge of the tool 5 is defined as three orthogonal components of a tool tangential cutting force Fₜₛ, a tool radial cutting force Fᵣₛ, and a tool axial cutting force Fₐₛ. The tool tangential cutting force Fₜₛ, the tool radial cutting force Fᵣₛ, and the tool axial cutting force Fₐₛ can be calculated using respective Formulae 3 to 5.

$${F}_{ts} ( θ ) = ( {K}_{tc} A ( θ ) + {K}_{te} l ) g ( θ ) \qquad Formula 3$$

$${F}_{rs} ( θ ) = ( {K}_{rc} A ( θ ) + {K}_{re} l ) g ( θ ) \qquad Formula 4$$

$${F}_{as} ( θ ) = ( {K}_{ac} A ( θ ) + {K}_{ae} l ) g ( θ ) \qquad Formula 5$$

Here, a tool tangential cutting coefficient K_{tc}, a tool radial cutting coefficient K_{rc}, and a tool axial cutting coefficient K_{ac} are the cutting forces per unit cutting cross-sectional area. A function g is a unit step function that distinguishes whether or not the cutting edge of the tool 5 is involved in the cutting. The function g is 1 during cutting and 0 during non-cutting.

On the other hand, a tool tangential cutting coefficient Kₜₑ, a tool radial cutting coefficient Kᵣₑ, and a tool axial cutting coefficient Kₐₑ are the cutting forces per unit cutting edge length. A cutting edge length/which is involved cutting can be regarded as the axial depth of cut dₐ. Accordingly, a cutting cross-sectional area A can be calculated using Formula 6.

$$A ( θ ) = h ( θ ) {d}_{a} \qquad Formula 6$$

$$h ( θ ) \approx {f}_{z} sin θ$$

$${f}_{z} = {f}_{r} / Z$$

Here, h is a nominal thickness of cut, and f_{z} is the feeding amount per edge of the tool 5.

The cutting is performed when φₛₜ≤φ≤φₑₓ, and when the tool radial depth of cut dᵣ is expressed as a ratio to the tool diameter of the tool 5, in the case of up-cutting, φₛₜ and φₑₓ can be calculated using Formula 7. On the other hand, in the case of down-cutting, φₛₜ and φₑₓ can be calculated using Formula 8.

$${Φ}_{st} = 0 , {Φ}_{ex} {cos}^{- 1} ( 1 - {d}_{r} ) \qquad Formula 7$$

$${Φ}_{st} = π - {cos}^{- 1} ( 1 - {d}_{r} ) , {Φ}_{e x} = π \qquad Formula 8$$

The cutting forces calculated by Formulae 3 to 5 can be converted into a cutting force component Fₓₛ in the X-axis direction, a cutting force component F_{ys} in the Y-axis direction, and a cutting force component F_{zs} in the Z-axis direction, respectively, by using Formulae 9 to 11.

$${F}_{xs} ( θ ) = {F}_{ts} ( θ ) cos θ + {F}_{r s} ( θ ) sin θ \qquad Formula 9$$

$${F}_{ys} ( θ ) = - {F}_{ts} ( θ ) sin θ + {F}_{rs} ( θ ) cos θ \qquad Formula 10$$

$${F}_{zs} ( θ ) = {F}_{as} ( θ ) \qquad Formula 11$$

As described above, conventionally, a sensor with a high response frequency such as a dynamometer has been used to acquire a cutting force change per rotation of the main spindle 4. The identification has been performed by optimizing the tool tangential cutting coefficient Kₜₑ, the tool radial cutting coefficient Kᵣₑ, and the tool axial cutting coefficient K_{ac} per the unit cutting cross-sectional area; and the tool tangential cutting coefficient Kₜₑ, the tool radial cutting coefficient Kᵣₑ, and the tool axial cutting coefficient Kₐₑ per the unit cutting edge length. The optimization has been performed such that the difference between the cutting force component Fₓₛ in the X-axis direction, the cutting force component F_{ys} in the Y-axis direction, and the cutting force component F_{zs} in the Z-axis direction for each rotation angle of the tool 5 is decreased. However, in the cutting force having the low response frequency, for example, in the cutting force that has been calculated based on the torque acquired from each axis motor of the machining center M, it has not been possible to identify the cutting coefficient with high accuracy.

Thus, as described above, the applicants have decided to use the average value of the torque acquired from each axis motor over a predetermined period to calculate the cutting force in each axis direction. Then, in conjunction with this, the applicants have devised Formulae 12 to 15 to calculate the average value also for the instantaneous cutting force model.

$$\overline{{F}_{ts}} = \frac{Z}{2 π} {\int }_{{Φ}_{st}}^{{Φ}_{ex}} {F}_{ts} ( θ ) d Φ = \frac{Z {d}_{a}}{2 π} ( - {K}_{tc} {f}_{z} C + {K}_{te} P ) \qquad Formula 12$$

$$\overline{{F}_{x s}} = \frac{Z}{2 π} {\int }_{{Φ}_{st}}^{{Φ}_{ex}} {F}_{xs} ( θ ) d Φ = \frac{{Zd}_{a}}{8 π} ( {K}_{r c} {f}_{z} ( 2 P - {S}_{2} ) + 2 {K}_{tc} {f}_{z} {S}_{3} + 4 {K}_{te} {S}_{1} - 4 {K}_{r e} C ) \qquad Formula 13$$

$$\overline{{F}_{y s}} = \frac{Z}{2 π} {\int }_{{Φ}_{st}}^{{Φ}_{ex}} {F}_{ys} ( θ ) d Φ = \frac{Z {d}_{a}}{8 π} ( - {K}_{tc} {f}_{z} ( 2 P - {S}_{2} ) + 2 {K}_{r c} {f}_{z} {S}_{3} + 4 {K}_{r e} {S}_{1} + 4 {K}_{r e} C ) \qquad Formula 14$$

$$\overline{{F}_{z s}} = \frac{Z}{2 π} {\int }_{{Φ}_{st}}^{{Φ}_{ex}} {F}_{zs} ( θ ) d Φ = \frac{Z {d}_{a}}{2 π} ( - {K}_{a c} {f}_{z} C + {K}_{a e} {d}_{a} P ) \qquad Formula 15$$

$$P = {Φ}_{ex} - {Φ}_{st}$$

$$C = cos {Φ}_{ex} - cos {Φ}_{st}$$

$${S}_{1} = sin {Φ}_{ex} - sin {Φ}_{st}$$

$${S}_{2} = sin 2 {Φ}_{ex} - cos 2 {Φ}_{st}$$

$${S}_{3} = {sin}^{2} {Φ}_{ex} - {sin}^{2} {Φ}_{st}$$

Here, the twist angle of the tool 5 does not affect an average cutting force component Fₜₛ (indicated by an overline meaning the average value, the same applies below) in a main spindle rotation direction. The twist angle of the tool 5 also does not affect an average cutting force component Fₓₛ⁻ in the X-axis direction, an average cutting force component F_{ys}⁻ in the Y-axis direction, and an average cutting force component F_{zs}⁻ in the Z-axis direction. Thus, it is possible to calculate the average cutting force components Fₜₛ⁻, Fₓₛ⁻, F_{ys}⁻, and F_{zs}⁻ in the main spindle rotation direction and each feed shaft direction for the instantaneous cutting force model by using Formulae 12 to 15, even when the tool 5 is, for example, an end mill having a twist angle. In the embodiment, the average cutting force components Fₜₛ⁻, Fₓₛ⁻, F_{ys}⁻, and F_{zs}⁻ in the main spindle rotation direction and each feed shaft direction calculated in this manner are treated as the estimated cutting forces.

In the case illustrated in FIGS. 3A and 3B, an example of identifying the cutting coefficient using the acquired cutting force is indicated below. Here, when the cutting force is acquired using the feed shaft, the torque of the X-axis motor that is an operational axis is used because a stationary axis tends to have large errors. In FIGS. 3A and 3B, the cutting force predicted by the instantaneous cutting force model is superimposed on actual torque data during non-cutting.

In the machining, it was assumed that an end mill having a tool diameter D=20 mm and a tool edge count Z=4 was used as the tool 5. The conditions of a tool axial depth of cut dₐ=5 mm, and a tool radial depth of cut dᵣ=25% as a ratio to the tool diameter were assumed. The workpiece 7 was assumed to be S45C carbon steel. Then, as for machining contents, performing of the up-cutting was assumed. In the following, the tool radial depth of cut dᵣ is expressed as a ratio to the tool diameter.

When the cutting coefficients are identified from the cutting forces acquired from the motor of the main spindle 4 and the X-axis motor, unknown quantities are the tool tangential cutting coefficient Kₜₑ and the tool radial cutting coefficient Kᵣₑ per the unit cutting cross-sectional area, and the tool tangential cutting coefficient Kₜₑ and the tool radial cutting coefficient Kᵣₑ per the unit cutting edge length. In contrast, the cutting forces that can be acquired under one cutting condition are two of the cutting force Fₜₘ that the cutting edge of the tool 5 receives in the rotation direction of the main spindle 4 and the cutting force Fₓₘ that the workpiece 7 receives in the X-axis direction, which are less than the unknown quantities. Therefore, while there is a case where the cutting coefficient is successfully identified by devising an assigning method of an initial value of the cutting coefficient, it is desirable to acquire the cutting force under two or more cutting conditions.

Therefore, in the investigation example, the cutting forces in the optional period b where the cutting conditions are different from those in the period a are also used to identify the cutting coefficient. In the period a, it was assumed that the feeding amount fᵣ per main spindle rotation was 0.4 mm/rev, and in the period b, the feeding amount fᵣ per main spindle rotation was 0.8 mm/rev. The X-axis ball screw was assumed to have a lead L=16 mm and a mechanical efficiency n=95%. Each cutting force and each cutting coefficient related to the period b are calculated from average torques T_{bs}, T_{bx}, T_{by}, and T_{bz} of each axis motor in the period b in the same manner as in the period a.

Under the above-described conditions, an evaluation value Eₜ of differences between an average value Fₜₘₐ and an average value Fₜₛₐ and between an average value F_{tmb} and an average value F_{tsb} is calculated using Formula 16. The average value Fₜₘₐ is an average value of the cutting force that the cutting edge of the tool 5 receives in the rotation direction of the main spindle 4 in the period a, which is acquired from the main spindle motor. The average value F_{tmb} is an average value of the cutting force that the cutting edge of the tool 5 receives in the rotation direction of the main spindle 4 in the period b, which is acquired from the main spindle motor. The average value Fₜₛₐ is an average value of the tool tangential component of the cutting force estimated for the cutting conditions in the period a using the temporarily determined cutting coefficient. The average value F_{tsb} is an average value of the tool tangential component of the cutting force estimated for the cutting conditions in the period b using the temporarily determined cutting coefficient. Based on the calculated evaluation value Eₜ, the tool tangential cutting coefficient K_{tc} per unit cutting cross-sectional area and the tool tangential cutting coefficient Kₜₑ per unit cutting edge length are identified.

$${E}_{t} = \sqrt{{( {F}_{tma} - {F}_{tsa} )}^{2} + {( {F}_{tmb} - {F}_{tsb} )}^{2}} \qquad Formula 16$$

As the initial values of the temporarily determined cutting coefficients, when the tool tangential cutting coefficient Kₜₑ per unit cutting cross-sectional area was 1000 MPa and the tool tangential cutting coefficient Kₜₑ per unit cutting edge length was 0 N/mm, each cutting force and the evaluation value Eₜ were as shown in Table 1.

TABLE 1

| | fᵣ | Fₜₘ | F̅ₜ̅ₛ̅ | (Fₜₘ − F̅ₜ̅ₛ̅)² |
|---|---|---|---|---|
| PERIOD a | 0.4 | 352 | 159 | 37189 |
| PERIOD b | 0.8 | 670 | 318 | 123686 |

| | |
|---|---|
| Eₜ | 401 |

The temporary determination of the cutting coefficient and the calculation of the evaluation value Eₜ were repeated, and each cutting force and the evaluation value Eₜ at the time when it was determined that the evaluation value Eₜ had become sufficiently small were as shown in Table 2. Accordingly, the cutting coefficients were identified as the tool tangential cutting coefficient K_{tc} per unit cutting cross-sectional area was 1998 MPa and the tool tangential cutting coefficient Kₜₑ per unit cutting edge length was 10 N/mm.

TABLE 2

| | fᵣ | Fₜₘ | F̅ₜ̅ₛ̅ | (Fₜₘ − F̅ₜ̅ₛ̅)² |
|---|---|---|---|---|
| PERIOD a | 0.4 | 352 | 352 | 0 |
| PERIOD b | 0.8 | 670 | 670 | 0 |

| | |
|---|---|
| Eₜ | 0 |

Next, an evaluation value Ex of a difference between the average value of the cutting force acquired from the X-axis motor and the average value of an X-axis direction component of the cutting force estimated using the temporarily determined cutting coefficient is also calculated in the same manner as in Formula 16. Based on the calculated evaluation value Eₓ, the tool radial cutting coefficient Kᵣₑ per unit cutting cross-sectional area and the tool radial cutting coefficient Kᵣₑ per unit cutting edge length are identified. For the tool tangential cutting coefficient Kₜₑ per unit cutting cross-sectional area and the tool tangential cutting coefficient Kₜₑ per unit cutting edge length, the values that have been identified above are used.

When, as the initial values of the temporarily determined cutting coefficients, the tool tangential cutting coefficient Kᵣₑ per unit cutting cross-sectional area was 1000 MPa and the tool radial cutting coefficient Kᵣₑ per unit cutting edge length was 0 N/mm, each cutting force and the evaluation value Eₓ were as shown in Table 3.

TABLE 3

| | fᵣ | Fₓₘ | F̅ₜ̅ₛ̅ | (Fₓₘ − F̅ₓ̅ₛ̅)² |
|---|---|---|---|---|
| PERIOD a | 0.4 | 358 | 364 | 39 |
| PERIOD b | 0.8 | 653 | 701 | 2281 |

| | |
|---|---|
| Eₓ | 48 |

The temporary determination of the cutting coefficients and the calculation of the evaluation value Eₓ were repeated, and each cutting force and the evaluation value Eₓ at the time when it was determined that the evaluation value Eₓ had become sufficiently small were as shown in Table 4. Accordingly, the cutting coefficients were identified as the tool radial cutting coefficient Kᵣₑ per unit cutting cross-sectional area was 575 MPa and the tool radial cutting coefficient Kᵣₑ per unit cutting edge length was 22 N/mm.

TABLE 4

| | fᵣ | Fₓₘ | F̅ₜ̅ₛ̅ | (Fₓₘ − F̅ₓ̅ₛ̅)² |
|---|---|---|---|---|
| PERIOD a | 0.4 | 358 | 358 | 0 |
| PERIOD b | 0.8 | 653 | 653 | 0 |

| | |
|---|---|
| Eₓ | 0 |

Accordingly, the tool tangential cutting coefficient Kₜₑ per unit cutting cross-sectional area and the tool radial cutting coefficient Kᵣₑ per unit cutting cross-sectional area; and the tool tangential cutting coefficient Kₜₑ per unit cutting edge length and the tool radial cutting coefficient Kᵣₑ per unit cutting edge length are identified, respectively. Here, in order to perform the identification of them, the torques acquired from respective axis motors included in the machining center M are used. Therefore, it is possible to identify the cutting coefficients with high accuracy without using additional sensors and irrespective of the material of the workpiece 7.

Subsequently, using the identified tool radial cutting coefficient Kᵣₑ per unit cutting cross-sectional area and tool tangential cutting coefficient Kₜₑ per unit cutting edge length, the cutting conditions that are the limit of the machining ability of the machining center M are calculated.

For the machining, a carbide end mill having a tool diameter D=16 mm, an edge count Z=4, and a twist angle of 0 degrees was assumed as the tool 5. A case in which the tool 5 held by a holder with a protrusion lₜ=80 mm was moved in the X-axis direction to up-cut S45C carbon steel as the workpiece 7 was assumed. Here, as the cutting coefficients, it was assumed that the tool radial cutting coefficient Kₜₑ per unit cutting cross-sectional area was 2000 MPa, the tool tangential cutting coefficient Kₜₑ per unit cutting edge length was 10 N/mm, the tool radial cutting coefficient Kᵣₑ per unit cutting cross-sectional area was 600 MPa, and the tool radial cutting coefficient Kᵣₑ per unit cutting edge length was 20 N/mm.

By using the cutting coefficient, a relationship between each cutting condition and a cutting force change per main spindle rotation is calculated by Formulae 3 to 11, and the cutting condition that is the limit of the machining ability is calculated.

For example, a main spindle motor output Pₛ during machining can be calculated by Formula 17 using an average value Fₜₐᵥₑ of the tool tangential cutting force.

$${P}_{s} = \frac{π {DSF}_{tave}}{60 \times {10}^{6} η} \qquad Formula 17$$

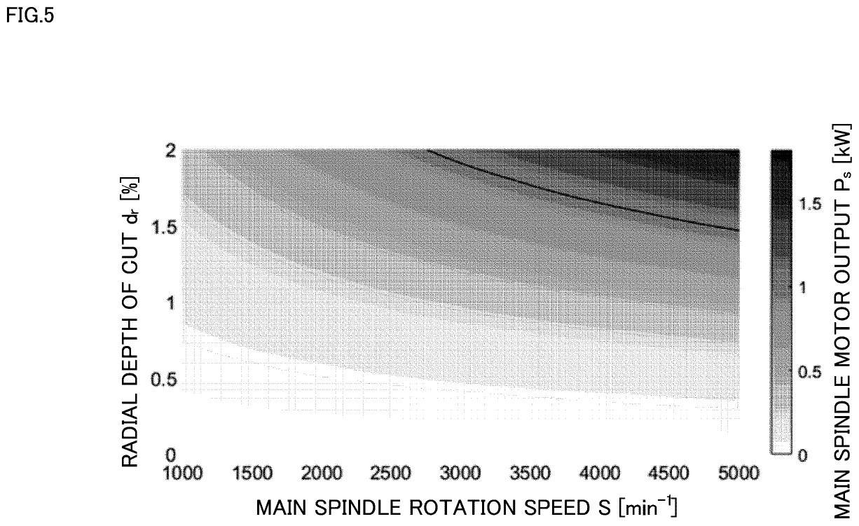

In FIG. 5, the relationship between the main spindle rotation speed S, the tool radial depth of cut dᵣ, and the main spindle motor output Pₛ during machining in a case of assuming that the tool axial depth of cut dₐ=20 mm, the feeding amount fᵣ per main spindle rotation is 0.8 mm/rev, and the mechanical efficiency η=95% as the conditions is showed. Here, the tool radial depth of cut dᵣ is a ratio to the diameter of the tool 5. In FIG. 5, conditions in which the required output for the main spindle motor is large are indicated in dark colors, and conditions in which the required output is small are indicated in bright colors. An output upper limit of the main spindle motor is assumed to be 10 kW. In this case, the black solid line connecting the points where the output of the main spindle motor is 10 KW indicates the cutting conditions that are the limit of the machining ability.

For example, a feed shaft motor output Pf during machining can be calculated by Formula 18 using an average value Fₓₐᵥₑ of a tool feed direction cutting force.

$${P}_{f} = \frac{{Sf}_{r} {F}_{xave}}{60 \times {10}^{6} η} \qquad Formula 18$$

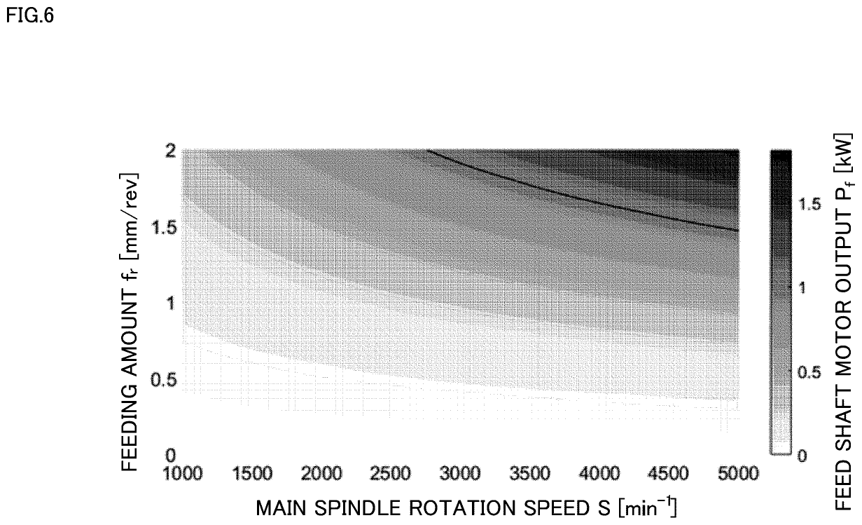

Next, in FIG. 6, the relationship between the main spindle rotation speed S, the feeding amount fᵣ per main spindle rotation, and the feed shaft motor output Pf during machining in a case of assuming that the tool axial depth of cut dₐ=20 mm, the tool radial depth of cut dᵣ=70%, and the mechanical efficiency n=95% as the conditions is indicated. The conditions in which the required output for the feed shaft motor is large are indicated in dark colors, and conditions in which the required output is small are indicated in bright colors. An output upper limit of the feed shaft motor is assumed to be 1 kW. In this case, the black solid line connecting the points where the output of the feed shaft motor is 1 kW indicates the cutting conditions that are the limit of the machining ability.

A bending stress σ acting on the tool 5 during machining can be calculated by Formula 20 using a maximum value Rₘₐₓ (Formula 19) of a resultant force R of a tool feed direction cutting force Fₓ and a cutting force F_{y} in a direction perpendicular to the tool feed direction and the tool axis direction.

$$R = \sqrt{{F}_{x}^{2} + {F}_{y}^{2}} \qquad Formula 19$$

$$σ = \frac{D {l}_{t} {R}_{max}}{2 I} \qquad Formula 20$$

Here, I indicates a cross-sectional secondary moment of the tool 5.

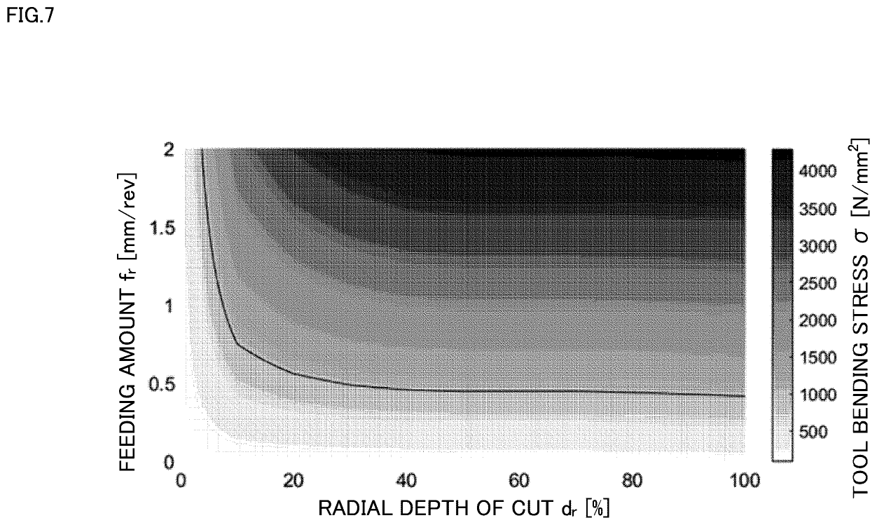

Further, in FIG. 7, the relationship between the tool radial depth of cut dᵣ, the feeding amount fᵣ per main spindle rotation, and the bending stress σ acting on the tool 5 during machining in a case of assuming that the tool axial depth of cut dₐ=20 mm, the main spindle rotation speed S=3000 min⁻¹ as the conditions is indicated. The cross-sectional secondary moment I of the tool 5 was calculated assuming that the tool 5 was a solid round bar. The conditions in which the bending stress σ acting on the tool 5 is large are indicated in dark colors, and the conditions in which the bending stress σ is small are indicated in bright colors. An allowable bending stress σ of the tool 5 is assumed to be 1000 N/mm². In this case, the black solid line connecting the points where the bending stress σ of the tool 5 is 1000 N/mm² indicates the cutting conditions that are the limit of the machining ability.

A shear stress τ acting on the tool 5 during machining can be calculated by Formula 21 using a maximum value Fₜₘₐₓ of the tool tangential cutting force.

$$τ = \frac{{D}^{2} {F}_{{t}_{max}}}{4 {I}_{p}} \qquad Formula 21$$

Here, Iₚ indicates a cross-sectional second polar moment of the tool 5.

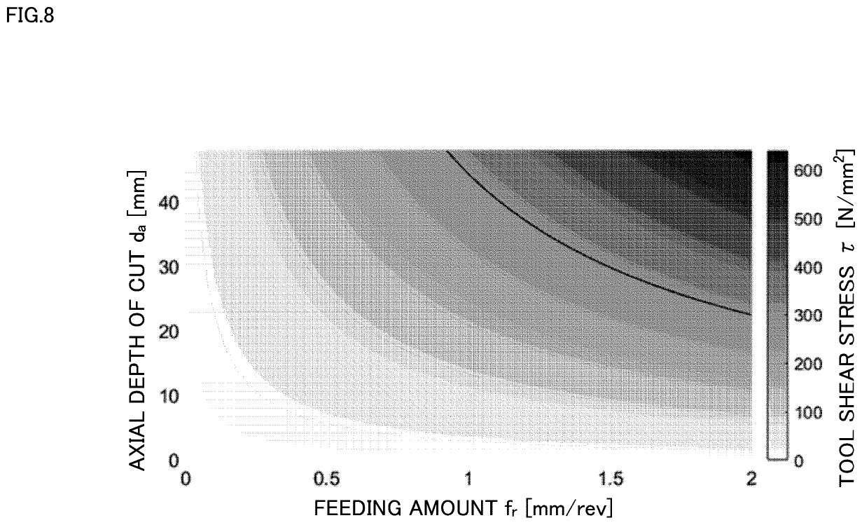

Subsequently, in FIG. 8, the relationship between the feeding amount fᵣ per main spindle rotation, the tool axial depth of cut dₐ, and the shear stress τ acting on the tool 5 during machining in a case of assuming that the tool radial depth of cut dᵣ=70% and the main spindle rotation speed S=3000 min⁻¹ as the conditions is indicated. The cross-sectional second polar moment Iₚ of the tool 5 was calculated assuming that the tool 5 was a solid round bar. The conditions in which the shear stress τ acting on the tool 5 is large are indicated in dark colors, and the conditions in which the shear stress τ is small are indicated in bright colors. An allowable shear stress τ of the tool 5 is assumed to be 300 N/mm². In this case, the black solid line connecting the points where the shear stress τ of the tool 5 is 300 N/mm² indicates the cutting conditions that are the limit of the machining ability.

Quality requirement values for the workpiece 7 include, for example, dimension accuracy, shape accuracy, surface roughness, and the like. Since, these are affected by deformation of the system including the tool 5 and the workpiece 7 due to the cutting force, it is necessary to calculate the cutting conditions that will become the limit of the machining ability, also taking into consideration of static rigidity and dynamic rigidity of the system including the tool 5 and the workpiece 7. For example, since the machining using the end mill as the tool 5 is an interrupted cutting, a relative displacement occurs between the tool 5 and the workpiece 7 due to a forced vibration. However, its magnitude must be smaller than the requirement value for the surface roughness. Thus, when a relative displacement amount is regarded as a surface roughness R_{z}, the surface roughness R_{z} can be calculated by performing a Fourier transformation on the cutting force F_{y} in the direction perpendicular to the tool feed direction and the tool axis direction, multiplying it by relative compliance between the tool 5 and the workpiece 7 for each frequency, and further performing an inverse Fourier transformation on the product.

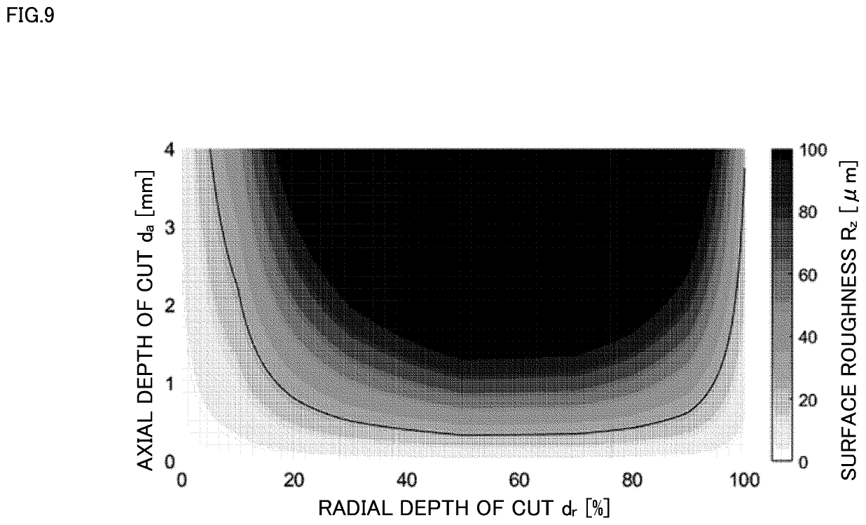

Here, regarding the tool 5, it is assumed that an equivalent mass m=0.05 kg, an equivalent attenuation coefficient c=47 N·s/m, and an equivalent rigidity k=11 MN/m. Furthermore, the relationship between the tool radial depth of cut dᵣ, the tool axial depth of cut dₐ, and the surface roughness R_{z} in a case of assuming that the workpiece 7 is a rigid body, and as the cutting conditions, the main spindle rotation speed S=3000 min⁻¹, and the feeding amount fᵣ per main spindle rotation is 0.8 mm/rev is indicated in FIG. 9. The conditions in which the surface roughness R_{z} is large are indicated in dark colors, and the conditions in which the surface roughness R_{z} is small are indicated in bright colors. The requirement value of the surface roughness R_{z} is assumed to be 25 μm. In this case, the black solid line connecting the points where the surface roughness R_{z} is 25 μm indicates the cutting conditions that are the limit of the machining ability.

The cutting conditions that are the stability limits of the self-excited chatter, which decreases machining accuracy and machined surface quality of a product, can be calculated by a method for obtaining a chatter stability limit diagram using a cutting coefficient K_{c} representing the cutting force per the unit cutting cross-sectional area. The method for obtaining a chatter stability limit diagram is indicated in, for example, “Eiji Shamoto, ‘Technical Commentary>Generation Mechanism and Suppression of Chatter Vibration in Cutting Machining,’ Electric Steelmaking Vol. 82, Issue 2, 2011, pp 143-155.”

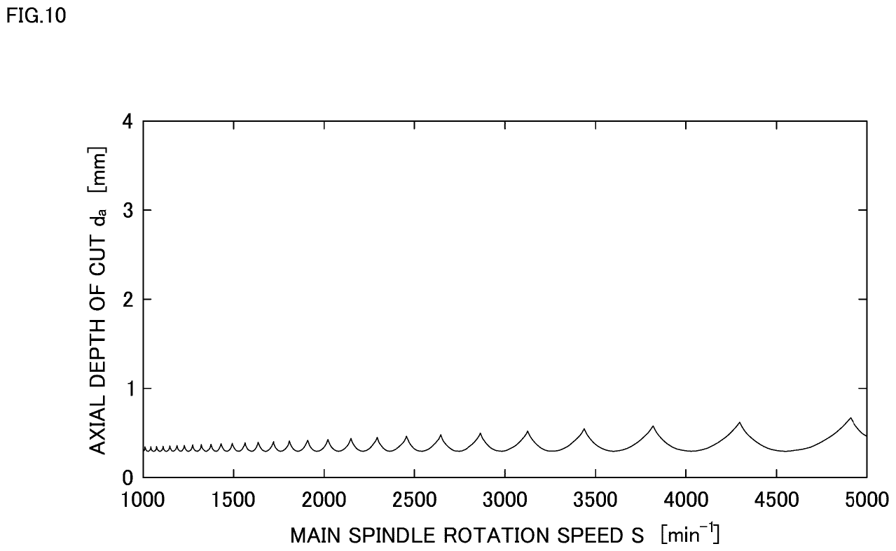

Here, for the tool 5, it is assumed that the equivalent mass m=0.05 kg, the equivalent attenuation coefficient c=47 N·s/m, and the equivalent rigidity k=11 MN/m. Furthermore, the relationship between the main spindle rotation speed S and the tool axial depth of cut dₐ in a stability limit cutting conditions of the self-excited chatter in a case of assuming that the workpiece 7 is a rigid body, and as cutting conditions, the tool radial depth of cut dᵣ=70%, and the feeding amount fᵣ per main spindle rotation is 0.8 mm/rev is indicated in FIG. 10. That is, the graph illustrated in FIG. 10 is the chatter stability limit diagram when the above-described conditions are assumed.

Thus, the cutting conditions that are the limits of the machining ability can be calculated in a multifaceted manner using the cutting coefficients identified by using the torques Tₐ, T_{b}, and T_{c} acquired from each axis motor included in the machining center M.

By using the calculated cutting conditions, machining satisfying the quality requirement values for the workpiece 7 can be performed while suppressing an occurrence of a breakage of the tool 5 and a self-excited chatter, within the output range of the machining center M. For example, the cutting conditions that would be a limit of the machining ability when the horizontal axis is the tool radial depth of cut dᵣ and the vertical axis is the tool axial depth of cut dₐ are calculated for the respective parameters. Here, parameters are the main spindle motor output Pₛ, the feed shaft motor output P_{f}, the bending stress σ acting on the tool 5, the shear stress τ acting on the tool 5, the surface roughness R_{z}, and the self-excited chatter. Then, for example, as shown in FIGS. 5 to 10, the limit of machining ability of the respective parameters is drawn as diagrams with black solid lines. Further, drawn diagrams are superimposed. After that, a combination of the tool radial depth of cut dᵣ and the tool axial depth of cut dₐ is selected so that the limits are not exceeded for all parameters. By selecting and setting the combination of the tool radial depth of cut dᵣ and the tool axial depth of cut dₐ as described above, machining that satisfies the quality requirement values for the workpiece 7 can be performed while suppressing an occurrence of a breakage of the tool 5 and a self-excited chatter within the range of the machine output. Furthermore, when there is a plurality of the combination of the tool radial depth of cut dᵣ and the tool axial depth of cut dₐ, the machining efficiency is calculated as the product of the tool radial depth of cut dᵣ, the tool axial depth of cut dₐ, the feeding amount fᵣ per main spindle rotation, and the main spindle rotation speed S for each combination of the tool radial depth of cut dᵣ and the tool axial depth of cut dₐ. From the calculation results, the productivity can be improved by selecting the combination of the tool radial depth of cut dᵣ and the tool axial depth of cut dₐ that maximizes the machining efficiency.

The horizontal axis and the vertical axis may be any of the tool radial depth of cut dᵣ, the tool axial depth of cut dₐ, the feeding amount fᵣ per main spindle rotation, and the main spindle rotation speed S.

When considering even a tool change, the tool diameter D, the edge count Z, and the protrusion lₜ may be used.

The machining center M includes the main spindle 4 on which the tool 5 is attached and driven by a tool main spindle motor and a ball screw that is the feed shaft relatively moving the tool 5 and the workpiece 7 by the feed shaft motor. In the machining center M, the cutting coefficient identification system 21 in the machine tool with the above-described configuration includes the measured cutting force acquisition unit 22, the tool information acquisition unit 23, the cutting condition acquisition unit 24, the estimated cutting force calculation unit 25, and the cutting coefficient identification unit 26. The measured cutting force acquisition unit 22 acquires average torques Tₐ of the main spindle motor and the feed shaft motor in the optional period a while the tool 5 is cutting the workpiece 7 to calculate a measured cutting force Fₘ. The tool information acquisition unit 23 acquires the tool information including the tool edge count Z corresponding to the measured cutting force Fₘ. The cutting condition acquisition unit 24 acquires the cutting conditions that correspond to the measured cutting force Fₘ, including the feeding amount fᵣ per main spindle rotation corresponding to the relative movement amount between the tool 5 and the workpiece 7 during one rotation of the main spindle 4, the tool axial depth of cut dₐ, and the tool radial depth of cut dᵣ. The estimated cutting force calculation unit 25 calculates the estimated cutting force Fₛ⁻, which is the average cutting force during one rotation of the main spindle 4, based on a calculation formula including the cutting coefficient K_{c} representing the cutting force per unit cutting cross-sectional area, the cutting coefficient K_{c} representing the cutting force per unit cutting edge length, the tool edge count Z, the feeding amount fᵣ per main spindle rotation, the tool axial depth of cut dₐ, and the tool radial depth of cut dᵣ. The cutting coefficient identification unit 26 identifies the cutting coefficient K_{c} and the cutting coefficient K_{c} by comparing the measured cutting force Fₘ with the estimated cutting force Fₛ⁻.

The cutting coefficient identification system 21 includes the limit cutting condition calculation unit 27. The limit cutting condition calculation unit 27 calculates the limit cutting conditions including at least one of the rotation speed S of the main spindle 4, the feeding amount fᵣ per main spindle rotation corresponding to the relative movement amount between the tool 5 and the workpiece 7 during one rotation of the main spindle 4, the tool axial depth of cut dₐ, and the tool radial depth of cut dᵣ, which are the limits of the machining ability of the machine tool, using at least one of the cutting coefficient K_{c} and the cutting coefficient K_{c}.

The measured cutting force acquisition unit 22 calculates the measured cutting force further using an average torque T_{b} in the optional period b during which the tool 5 is cutting the workpiece 7 under cutting conditions different from those for the optional period a.

The measured cutting force acquisition unit 22 calculates the measured cutting force further using an average torque T_{c} in the optional period c during non-cutting.

Parameters that determine the limits of the machining ability include at least one of the output upper limits of at least one of the tool main spindle motor, a workpiece main spindle motor, and the feed shaft motor, the bending stress σ of the tool 5, the shear stress τ, the surface roughness R_{z} that is the quality requirement value of the workpiece, and the stability limit of the self-excited chatter.

Then, each of the cutting coefficient K_{c} per unit cutting cross-sectional area and the cutting coefficient K_{c} per unit cutting edge length is identified using the torques Tₐ, T_{b}, and T_{c} acquired from each axis motor included in the machining center M. Thus, the cutting coefficient K_{c} and the cutting coefficient K_{c} can be identified with high accuracy without using additional sensors and irrespective of the material of the workpiece 7. The cutting conditions that are the limits of the machining ability can be calculated in a multifaceted manner by using the cutting coefficients identified using the torques Tₐ, T_{b}, and T_{c} acquired from each axis motor included in the machining center M.

The configurations of the cutting coefficient identification system in a machine tool and the cutting coefficient identification method in a machine tool of the present disclosure are not limited to the aspects described in the above-described embodiments and can be appropriately modified without departing from the spirit of the invention.

For example, in the embodiment, the measured cutting force is acquired from the torque history of actual machining after the cutting is completed. However, the measured cutting force may be acquired during the cutting.

In the embodiment, the machine information acquisition unit acquires the ball screw specifications from the NC device. However, it may acquire the ball screw specifications from a source other than the NC device, or the ball screw specifications may be directly input by, for example, disposing a separate input unit.

In the embodiment, the tool information acquisition unit acquires the tool information from the NC device. However, it may acquire the tool information from a source other than the NC device, or the tool information may be directly input by, for example, disposing a separate input unit.

In the embodiment, the cutting condition acquisition unit acquires the cutting conditions based on a program. However, the cutting conditions may be directly input by, for example, disposing a separate input unit.

In the embodiment, the cutting coefficient is identified using the torque required for cutting that is acquired by taking the difference between the motor torque during non-cutting and the motor torque during cutting. However, by utilizing a disturbance observer technique, the cutting coefficient may also be identified by acquiring the torque required for cutting without using the motor torque during non-cutting.

In the embodiment, the cutting force is acquired under two conditions where the feeding amounts per main spindle rotation were different. However, the cutting force may be acquired under conditions where parameters such as the tool axial depth of cut and the tool axial depth of cut are different, and the feeding amount per main spindle rotation in this case may be identical.

In the embodiment, the tangential cutting coefficient K_{tc} per unit cutting cross-sectional area and the tool tangential cutting coefficient Kₜₑ per unit cutting edge length; and the tool radial cutting coefficient K_{rc} per unit cutting cross-sectional area and the tool radial cutting coefficient Kᵣₑ per unit cutting edge length are identified in sequence. However, all of them may be simultaneously identified by combining the evaluation values Eₜ and Eₓ.

In the embodiment, the identification of the cutting coefficients and the prediction of the machining ability are performed continuously. However, the identified cutting coefficients may be associated with the tool information and the like to store it in a database, and the machining ability may be predicted by retrieving the stored cutting coefficients from the database on another occasion.

In the embodiment, the identification of the cutting coefficients and the prediction of the machining ability are performed from the information on the tool main spindle. However, instead of the tool main spindle, the identification of the cutting coefficients and the prediction of the machining ability may be performed from the information on the workpiece main spindle rotatable by the workpiece main spindle motor, or it may be performed from the information on both the tool main spindle and the workpiece main spindle.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A cutting coefficient identification system in a machine tool, the machine tool including at least one of a tool main spindle with a tool attached and driven by a tool main spindle motor; and a workpiece main spindle with a workpiece attached and driven by a workpiece main spindle motor; and a feed shaft that relatively moves the tool and the workpiece by a feed shaft motor, the cutting coefficient identification system comprising:
a measured cutting force acquisition unit that acquires an average torque Tₐ of at least one of the tool main spindle motor, the workpiece main spindle motor, and the feed shaft motor in an optional period a while the tool is cutting the workpiece and calculates a measured cutting force;
a tool information acquisition unit that acquires tool information including a tool edge count corresponding to the measured cutting force;
a cutting condition acquisition unit that acquires cutting conditions that correspond to the measured cutting force, the cutting conditions including a relative movement amount between the tool and the workpiece during one rotation of the tool main spindle or the workpiece main spindle and a depth of cut;
an estimated cutting force calculation unit that calculates an estimated cutting force that is an average cutting force during one rotation of the tool main spindle or the workpiece main spindle, based on a calculation formula including a cutting coefficient K_{c} representing a cutting force per unit cutting cross-sectional area, a cutting coefficient Kₑ representing a cutting force per unit cutting edge length, the tool edge count, the relative movement amount, and the depth of cut; and
a cutting coefficient identification unit that identifies the cutting coefficient K_{c} and the cutting coefficient K_{c} by comparing the measured cutting force with the estimated cutting force.

2. The cutting coefficient identification system in the machine tool according to claim 1, further comprising
a limit cutting condition calculation unit that calculates a limit cutting condition that includes at least one of a rotation speed of the tool main spindle or the workpiece main spindle, the relative movement amount between the tool and the workpiece during one rotation of the tool main spindle or the workpiece main spindle, and the depth of cut, which are the limits of the machining ability of the machine tool, using at least one of the cutting coefficient K_{c} and the cutting coefficient Kₑ.

3. The cutting coefficient identification system in the machine tool according to claims 1, wherein
the measured cutting force acquisition unit calculates the measured cutting force by further using an average torque T_{b} in an optional period b during which the tool is cutting the workpiece under cutting conditions different from the cutting conditions in the optional period a.

4. The cutting coefficient identification system in the machine tool according to claims 1, wherein
the measured cutting force acquisition unit calculates the measured cutting force by further using an average torque T_{c} in an optional period c during non-cutting.

5. The cutting coefficient identification system in the machine tool according to claims 2, wherein
the measured cutting force acquisition unit calculates the measured cutting force by further using an average torque T_{b} in an optional period b during which the tool is cutting the workpiece under cutting conditions different from the cutting conditions in the optional period a.

6. The cutting coefficient identification system in the machine tool according to claims 2, wherein
the measured cutting force acquisition unit calculates the measured cutting force by further using an average torque T_{c} in an optional period c during non-cutting.

7. The cutting coefficient identification system in the machine tool according to claim 2, wherein
parameters that determine a limit of the machining ability include: at least one of an output upper limit of at least one of the tool main spindle motor, the workpiece main spindle motor, and the feed shaft motor; a bending stress of the tool; a shear stress of the tool; a quality requirement value of the workpiece; and a stability limit of self-excited chatter.

8. A cutting coefficient identification method in a machine tool, the machine tool including at least one of a tool main spindle with a tool attached and driven by a tool main spindle motor; and a workpiece main spindle with a workpiece attached and driven by a workpiece main spindle motor; and a feed shaft that relatively moves the tool and the workpiece by a feed shaft motor, the cutting coefficient identification method comprising:
acquiring an average torque Tₐ of at least one of the tool main spindle motor, the workpiece main spindle motor, and the feed shaft motor in an optional period a while the tool is cutting the workpiece, and calculating a measured cutting force;
acquiring tool information including a tool edge count corresponding to the measured cutting force;
acquiring cutting conditions that correspond to the measured cutting force, the cutting conditions including a relative movement amount between the tool and the workpiece during one rotation of the tool main spindle or the workpiece main spindle and a depth of cut;
calculating an estimated cutting force that is an average cutting force during one rotation of the tool main spindle or the workpiece main spindle, based on a calculation formula including a cutting coefficient K_{c} representing a cutting force per unit cutting cross-sectional area, a cutting coefficient K_{c} representing a cutting force per unit cutting edge length, the tool edge count, the relative movement amount, and the depth of cut; and
identifying the cutting coefficient K_{c} and the cutting coefficient K_{c} by comparing the measured cutting force with the estimated cutting force.
